(19) United States
(12) Patent Application Publication
(10) Pub. No.: US 2025/0254740 A1
(43) Pub. Date: Aug. 7, 2025

(54) METHOD AND APPARATUS FOR ASSIGNING REMOTE UE ID FOR U2U RELAYING

(71) Applicant: SAMSUNG ELECTRONICS CO., LTD., Suwon-si, Gyeonggi-do (KR)

(72) Inventors: Milos TESANOVIC, Staines, Middlesex (GB); Hyunjeong KANG, Suwon-si (KR)

(21) Appl. No.: 18/856,858

(22) PCT Filed: Apr. 13, 2023
(86) PCT No.: PCT/KR2023/005024

§ 371 Date: Oct. 14, 2024

(30) Foreign Application Priority Data
Apr. 14, 2022 (GB) 2205596.6

(51) Int. Cl. H04W 76/14; H04W 8/00; H04W 28/02; H04W 76/20; H04W 92/18

(52) U.S. Cl. CPC H04W 76/14; H04W 8/005; H04W 28/0273; H04W 76/20; H04W 92/18

(57) ABSTRACT

Disclosed is a method related to a 5G or 6G communication system for supporting a higher data transmission rate. According to an embodiment, a method performed by a first user equipment (UE) in a wireless communication system is provided. The method comprises configuring at least one UE identifier (ID) for one or more UEs in a relay network, establishing a direct connection for sidelink communication with a relay UE for connecting the first UE and a second UE and transmitting, to the relay UE, information on the at least one UE ID.

### TECHNICAL FIELD

The present disclosure relates generally to wireless communication systems and, more specifically, to dynamic adaptation of a time domain resource for periodic or semi-persistent downlink signals.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to an embodiment, a method performed by a first user equipment (UE) in a wireless communication system is provided. The method comprises configuring at least one UE identifier (ID) for one or more UEs in a relay network, establishing a direct connection for sidelink communication with a relay UE for connecting the first UE and a second UE and transmitting, to the relay UE, information on the at least one UE ID.

According to an embodiment, a first user equipment (UE) in a wireless communication system is provided. The first user equipment comprises a transceiver and a controller coupled with the transceiver and configured to configure at least one UE identifier (ID) for one or more UEs in a relay network, establish a direct connection for sidelink communication with a relay UE for connecting the first UE and a second UE and transmit, to the relay UE, information on the at least one UE ID.

According to an embodiment, a method performed by a relay user equipment (UE) in a wireless communication system is provided. The method comprises establishing a direct connection for sidelink communication with a first UE and receiving, from the first UE, information on at least one UE ID associated with one or more UEs in a relay network.

According to an embodiment, a relay user equipment (UE) in a wireless communication system is provided. The relay UE comprises a transceiver and a controller coupled with the transceiver and configured to establish a direct connection for sidelink communication with a first UE and receive, from the first UE, information on at least one UE ID associated with one or more UEs in a relay network.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates one example architecture for a UE-to-UE relay network within a communications network according to an embodiment;

FIG. 2 illustrates an exemplary UE of the UE-to-UE relay network according to an embodiment;

FIG. 3 illustrates a user plane protocol stack for a L2 UE-to-UE relay network;

FIG. 4 illustrates a control plane protocol stack for the L2 UE-to-UE relay network;

FIG. 5 illustrates a structure of a UE according to an embodiment of the disclosure; and

FIG. 6 illustrates a structure of a base station according to an embodiment of the disclosure.

### BEST MODE FOR CARRYING OUT THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made.

The following examples are applicable to, and use terminology associated with, 3GPP 5G. However, the skilled person will appreciate that the techniques disclosed herein are not limited to these examples or to 3GPP 5G, and may be applied in any suitable system or standard, for example one or more existing and/or future generation wireless communication systems or standards. The skilled person will appreciate that the techniques disclosed herein may be applied in any existing or future releases of 3GPP 5G NR or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

The following description relates to a UE-to-UE (U2U) relay network and a method for assigning a SRAP UE ID to a UE in the UE-to-UE (U2U) relay network. However, it will be appreciated that the method of UE ID assignment applies to other relay networks, such UE-to-Network relay networks and non-sidelink-based relay networks, and applies to other UE IDs.

In 3GPP 5G communication networks, communication between UEs, in a UE-to-UE relay network, is an important area of development. This enables signalling and data to be transferred between UEs without using other communication network infrastructure, such as base stations. A UE-to-UE relay network is a powerful technology for increasing communication network throughput.

In a UE-to-UE relay network, a Relay UE can provide communication network connection for other, Remote, UEs. The UE-to-UE relay network extends communication network connectivity as the Relay UE connects to the communication network and communicates, via sidelink (SL) transmissions, with the Remote UEs. The UE-to-UE relay network enables coverage extension in the communication network, which is especially important for the partial coverage scenario. In this, at least one of the UEs (Relay UE, Remote UE) involved in relaying SL transmissions is in-coverage of a base station of the communication network and at least one of the UEs involved in relaying the SL transmissions is out-of-coverage. When the Relay UE is in-coverage, it can access a device of the communication network to receive data therefrom. The Relay UE can then relay the data to one or more Remote UEs, which may be out-of-coverage and unable to receive the data directly from the communication network.

In UE-to-UE relay networks, there remain issues with identification of UEs in the relay network to other UEs in the relay network.

The above information is presented as background information only to assist with an understanding of the present disclosure. No determination has been made, and no assertion is made, as to whether any of the above might be applicable as prior art with respect to the present invention.

Certain examples of the present disclosure provide various techniques relating to user equipment (UE) identifiers, particularly but not exclusively, sidelink relay adaptation protocol (SRAP) identifiers (IDs), and particularly techniques for assigning UE IDs and SRAP UE IDs for example within 3^{rd} Generation Partnership Project (3GPP) 5th Generation (5G) relay networks.

### ABBREVIATIONS/DEFINITIONS

In the present disclosure, the following abbreviations and definitions may be used.
3GPP 3^{rd} Generation Partnership Project
5G 5th Generation
CP Control Plane
DL Downlink
DST Destination
gNB 5G base station
ID Identifier/Identification
IP Internet Protocol
LTE Long Term Evolution
MAC Medium Access Control
NR New Radio
PDCP Packet Data Conversion Protocol
PHY Physical
Rel Release
RLC Radio Link Control
RRC Radio Resource Control
Rx Receive
SDAP Service Data Adaptation Protocol
SL Sidelink
SRAP Sidelink Relay Adaptation Protocol
SRC Source
TR Technical Report
TS Technical Specification
Tx Transmit
UE User Equipment
UL Uplink
Uu Air interface between terminal and base station/access point

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims. Embodiments or examples disclosed in the description and/or figures falling outside the scope of the claims are to be understood as examples useful for understanding the present invention.

Other aspects, advantages, and salient features of the invention will become apparent to those skilled in the art from the following detailed description taken in conjunction with the accompanying drawings.

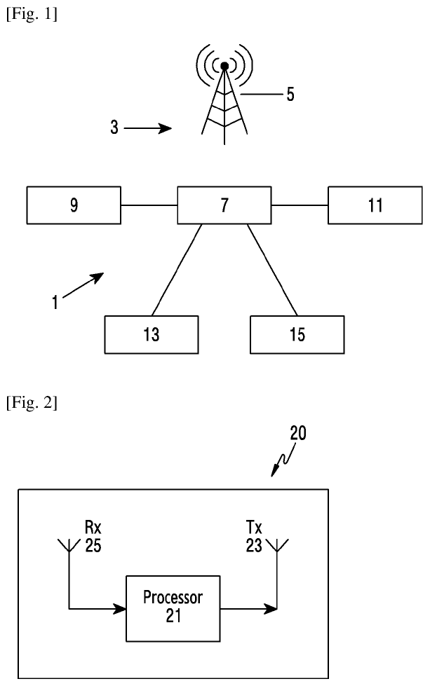

FIG. 1 illustrates one example architecture for a UE-to-UE (U2U) relay network 1 within a communication network 3.

Referring to FIG. 1, the communication network 3 comprises a base station 5, which may be a 5G base station, gNB. In this example architecture, the UE-to-UE relay network 1 comprises a Relay UE 7, a first source (SRC) Remote UE 9, a second SRC Remote UE 11, a first destination (DST) Remote UE 13 and a second DST Remote UE 15. This arrangement provides a possibility of multiple DST Remote UEs for a single SRC Remote UE and multiple SRC Remote UEs for a DST Remote UE. It will be appreciated that other example architectures of the UE-to-UE relay network may comprise further Relay UEs and more or less SRC and DST Remote UEs.

According to an embodiment, the Relay UE 7 is within range of the base station 5. The SRC Remote UEs 9, 11 and the DST Remote UEs 13, 15 are within range of the Relay UE 7 (allowing communication between the Remote UEs) but out of range of the base station 5. It will be appreciated that in other example architectures of the UE-to-UE relay network one or more of the SRC and DST Remote UEs may be within range of the base station.

According to an embodiment, the Relay UE 7 is connected to the base station 5 by any suitable technology, for example, a Uu radio interface link, for uplink (UL) and downlink (DL) transmissions. The Relay UE 7 establishes a one-to-one direct connection for sidelink (SL) transmissions with each of the Remote UEs 9, 11, 13, 15, using PC5 signalling protocol links. Relaying of data between a SRC Remote UE and a DST Remote UE can occur once a PC5 link is established between the SRC Remote UE, the Relay UE and the DST Remote UE. The Relay UE 7 relays traffic between the Uu interface link with the base station and the PC5 links with the Remote UEs and will need to carry out mapping of UL and DL bearers onto SL bearers and vice versa.

As captured in 3GPP TR 38.836 v17.0.0, UE-to-UE (U2U) relay networks enable coverage extension of SL transmissions between two Remote UEs. This is especially important for the partial coverage scenario, in which at least one of the UEs involved in relaying data (SRC Remote UE, Relay UE, DST Remote UE) is in-coverage of the base station 5 and at least one of the UEs involved in relaying the data is out-of-coverage of the base station 5. When the Relay UE 7 is in-coverage, it can access the communication network 3 via the Uu link between the Relay UE 7 and the base station 5.

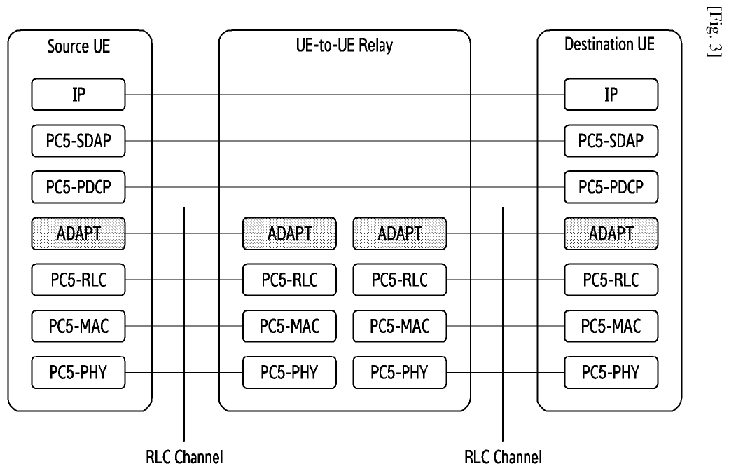

FIG. 2 is a schematic representation of an exemplary UE 20 (Relay UE, SRC Remote UE or DST Remote UE) of the UE-to-UE relay network 1 of FIG. 1.

Referring to FIG. 2, the UE 20 comprises a processor (or controller) 21, a transmitter 23 and a receiver 25. The receiver 25 is configured for receiving one or more transmissions from one or more other UEs of the network 1. The transmitter 23 is configured for transmitting one or more transmissions to one or more other UEs of the network 1. The processor 21 is configured for performing operations as described herein, particularly assigning one or more SRAP UE IDs.

FIG. 3 illustrates User and Control plane protocol stacks for an L2 UE-to-UE (U2U) relay network.

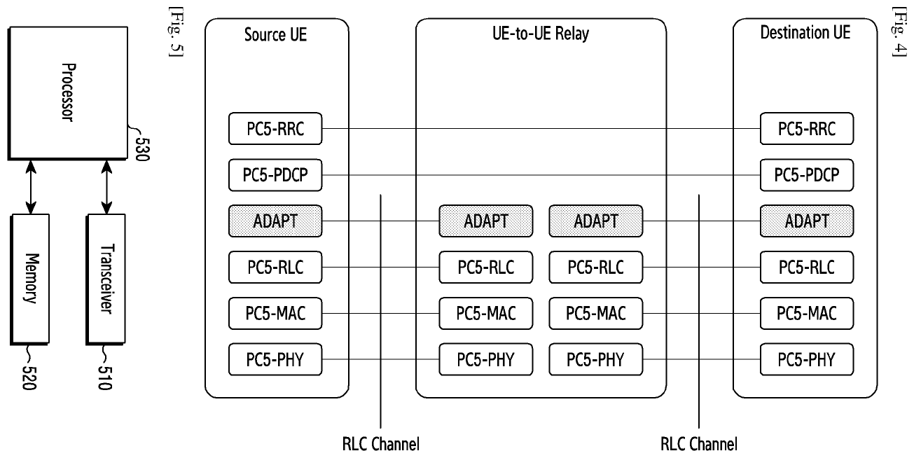

FIG. 4 illustrates User and Control plane protocol stacks for an L2 UE-to-UE (U2U) relay network.

Referring to FIG. 3 and FIG. 4, the 3GPP agreed the introduction of the Adapt layer on the PC5 links between UEs. The Adapt layer is also present on the Uu link, between the Relay UE and the base station, for UE-to-Network (U2N) relaying.

The main agreed functionality of the U2N Adapt layer on the Uu link is mapping of PC5 bearers onto Uu bearers for UL transmission from the Relay UE, and performing the inverse process for DL transmissions. The main agreed functionality of the Adapt layer on the PC5 links between UEs is mapping of bearers onto PC5 RLC channels (applicable to both U2N and U2U relaying).

The Adapt layer is referred to as the sidelink relay adaptation protocol (SRAP). The following is the basic model and operation of SRAP for SL transmissions in UE-to-Network (U2N) relay networks, as agreed by 3GPP:
On the U2N Relay UE, the SRAP sublayer contains one SRAP entity at the Uu interface and a separate collocated SRAP entity at the PC5 interface of the UE. On the U2N Remote UEs, the SRAP sublayer contains only one SRAP entity at the PC5 interfaces.
Each SRAP entity has a transmitting part and a receiving part. Across the PC5 interface of a U2N Remote UE, the transmitting part of the SRAP entity has a corresponding receiving part of an SRAP entity of the U2N Relay UE, and vice-versa. Across the Uu interface of the U2N Relay UE, the transmitting part of the SRAP entity has a corresponding receiving part of an SRAP entity at the base station, and vice-versa.
At a U2N Remote UE, in the UL direction, the SRAP determines an SRAP UE ID and a BEARER ID and adds these to an SRAP header. At a U2N Remote UE, on the DL direction, the SRAP will remove the SRAP header and deliver the packet to higher layers of the U2N Remote UE.
At the U2N Relay UE, in the UL direction, the SRAP will map a packet from a PC5 channel to a Uu channel using the SRAP UE ID and the BEARER ID contained in the packet itself, and the mapping configuration provided by the network. At the U2N Relay UE, in the DL direction, the SRAP will map the packet from the Uu channel to a PC5 channel using the SRAP UE ID and the BEARER ID contained in the packet itself, and the mapping configuration provided by the network.

In a U2U relay network, we do not talk about UL and DL on the PC5 interface—we talk about Tx UE and Rx UE behaviour, respectively. In a U2U relay network, the packets are communicated between SRC Remote UE and DST Remote UE via PC5 (sidelink). There is no Uu channel. The SRAP at the relay node maps a packet from a PC5 channel of SRC Remote UE-Relay UE link, to a PC5 channel of the Relay UE-DST Remote UE link. In U2N relay networks, the base station assigns an SRAP UE ID for both the Uu and PC5 links.

In certain examples of the UE-to-UE (U2U) relay network 1, at least one UE (SRC Remote UE, Relay UE, DST Remote UE) may be configured to assign a SRAP UE ID for one or more UEs of the UE-to-UE relay network 1. In certain examples, the at least one UE or each UE of the UE-to-UE relay network 1 may be configured to self-assign a SRAP UE ID. In certain examples, the at least one UE of the UE-to-UE relay network 1 may be configured to assign a SRAP UE ID for one or more other UEs of the UE-to-UE relay network 1. In certain examples, the at least one UE of the UE-to-UE relay network 1 may be configured to self-assign a SRAP UE ID and to assign a SRAP UE ID for one or more other UEs of the UE-to-UE relay network 1. In certain examples, the at least one UE of the UE-to-UE relay network 1 may be assigned a SRAP UE ID and assign a SRAP UE ID for one or more other UEs of the UE-to-UE relay network 1.

In certain examples, the Relay UE 7 of the UE-to-UE relay network 1 may be configured to self-assign a SRAP UE ID. In certain examples, the Relay UE 7 of the UE-to-UE relay network 1 may be configured to self-assign a SRAP UE ID and assign a SRAP UE ID for one or more or each of the Remote UEs 9, 11, 13, 15 of the UE-to-UE relay network 1. In certain examples, the Relay UE 7 of the UE-to-UE relay network 1 may be configured to be assigned a SRAP UE ID and assign a SRAP UE ID for one or more or each of the Remote UEs 9, 11, 13, 15 of the UE-to-UE relay network 1. In certain examples, the Relay UE 7 may be assigned a SRAP UE ID by a network entity of the communication network 3. In certain examples, the network entity may be a base station.

In certain examples, one or more or each of the Remote UEs 9, 11, 13 15 of the UE-to-UE relay network 1 may be configured to self-assign a SRAP UE ID. In certain examples, one or more of the Remote UEs 9, 11, 13 15 of the UE-to-UE relay network 1 may be configured to self-assign a SRAP UE ID and assign a SRAP UE ID for one or more other Remote UEs 9, 11, 13, 15 of the UE-to-UE relay network 1. In certain examples, one or more of the Remote UEs 9, 11, 13 15 of the UE-to-UE relay network 1 may be configured to be assigned a SRAP UE ID and assign a SRAP UE ID for one or more other Remote UEs 9, 11, 13 15 of the UE-to-UE relay network 1. In certain examples, the one or more Remote UEs 9, 11, 13 15 may be assigned a SRAP UE ID by the Relay UE 7.

In certain examples, the following changes may be made to a SRAP packet format:
Only one SRAP UE ID (e.g. a SRAP UE ID assigned to a Rx Remote UE i.e. a DST Remote UE SRAP UE ID) is included overall, as part of a SRAP header of a SRAP packet (e.g. the existing U2N SRAP packet format is adhered to, and/or a new U2U SRAP format supporting this example is devised),
Both SRAP UE IDs (e.g. a SRAP UE ID self-assigned by a Tx Remote UE and a SRAP UE ID assigned to the Rx Remote UE by a Tx Remote UE; or a SRAP UE ID self-assigned by a Tx Remote UE and a SRAP UE ID assigned by a Relay UE to the Rx Remote UE) are included as part of a SRAP header of a SRAP packet (this requires a new header format for UE-to-UE SRAP packets, different from a baseline UE-to-Network SRAP format),
Both SRAP UE IDs are included, one as part of a SRAP header, the other as part of the SRAP payload (this could reuse the UE-to-Network format assuming one of the reserved bits are used to flag the special content in the payload, or a new packet format could be devised).

In one example, different SRAP packet formats may be used for two UE links comprising a first link: Tx Remote UE to Relay UE and a second link: Relay UE to Rx Remote UE, e.g. include both SRAP UE IDs on the first link and only one SRAP UE ID, the Rx Remote UE ID, on the second link. In another example, the same SRAP packet format may be used for two UE links e.g. include both SRAP UE IDs on both links.

When the SRAP UE IDs are being assigned conflict may happen in the SRAP UE ID space. A conflict resolution procedure may be applied to the SRAP UE IDs assigned to the Relay UE and the Remote UEs.

In certain examples, one or more or each of the Remote UEs 9, 11, 13, 15 may send a self-assigned SRAP UE ID to the Relay UE 7 of the UE-to-UE relay network 1.

In certain examples, after each Remote UE 9, 11, 13, 15 detects the Relay UE 7 as a serving Relay UE, each Remote UE 9, 11, 13, 15 may establish a direct connection between it and the Relay UE 7. The Remote UEs 9, 11, 13, 15 and the Relay UE 7 will perform direct connection establishment procedures using legacy PC5-S signalling and set up PC5 RRC connections using legacy PC5-RRC messages. In one example, the SRAP Remote UE IDs are sent as part of the PC5 RRC reconfiguration (which as a result is modified compared to the baseline) from the Remote UEs 9, 11, 13, 15 to the Relay UE 7. The Remote UEs 9, 11, 13, 15 and the Relay UE 7 are aware of each other's SRC L2 ID and DST L2 ID (since the L2 IDs are used for direct connection establishment/PC5RRC connection establishment).

The Remote UEs 9, 11, 13, and 15 may then send their self-assigned SRAP UE IDs to the Relay UE 7 via the established connections and/or connections in the process of being established. This may comprise sending the self-assigned SRAP UE IDs via a PC5-S signalling transmission or via a PC5 radio resource control (RRC) message. The self-assigned SRAP UE IDs may be sent to the Relay UE 7 via the connections as part of a PC5 SRAP header of a packet transmission or as part of a PC5 SRAP payload of a packet transmission. Assignment of SRAP UE IDs to the Remote UEs and conflict resolution procedures can be handled via PC5 RRC or via SRAP control PDU.

In one example, when a SRC Remote UE 9, 11 (Tx Remote UE) sends SL data or SL signalling (e.g. PC5-S signalling) to a peer DST Remote UE 13, 15 (Rx Remote UE) via the serving (selected) Relay UE 7, the SRC Remote UE 9, 11 includes the self-assigned SRAP UE ID in the PC5 SRAP header of a packet transmission. The Relay UE 7 then obtains the self-assigned SRAP UE ID from the received PC5 SRAP header. Alternatively, the SRC Remote UE 9, 11 can include the self-assigned SRAP UE ID in a PC5 SRAP payload of packet transmissions to the Relay UE 7, using a special flag in the SRAP header associated with the payload (indicating the presence of a certain kind of payload and/or its size).

For communication with a peer DST Remote UE 13, 15, a SRC Remote UE 9, 11, in addition to including its self-assigned SRAP UE ID in the PC5 SRAP header, also needs to include the DST Remote UE SRAP UE ID. This SRAP UE ID may not be recognizable by the Relay UE 7, since the DST Remote UE 13, 15 may not yet have shared its self-assigned SRAP UE ID with the Relay UE 7 or may not yet have been assigned its SRAP UE ID. Therefore one open issue for communication with a peer DST Remote UE is how the self-assigned SRAP UE ID of the peer DST Remote UE is made available to the SRC Remote UE.

In certain examples, each SRC Remote UE 9, 11 sends its SRAP UE ID to peer DST Remote UEs 13, 15, and vice versa, as well as to the Relay UE 7, solving this issue. In another example, the Relay UE 7 can inform the peer SRC Remote UE 9, 11 of the SRAP UE ID of the DST Remote UE 13, 15, again solving the issue at hand.

In certain examples, the Relay UE 7 of the UE-to-UE relay network 1 may send one or more received Remote UE SRAP UE IDs to one or more other Remote UEs. During PC5 link establishment between the Remote UEs 9, 11, 13, 15 and the Relay UE 7, the SRAP UE IDs to be used in the PC5 SRAP headers can be conveyed by the Relay UE 7 to the Remote UEs 9, 11, 13, 15 via PC5-S signalling or PC5-RRC messages.

In certain examples, at least one SRC Remote UE 9, 11 of the UE-to-UE relay network 1 may be configured to assign temporarily a SRAP UE ID for a DST Remote UE 13, 15. The SRC Remote UE 9, 11 may send the SRAP UE ID to the Relay UE 7 and the Relay UE 7 may send the SRAP UE ID to the DST Remote UE 13, 15. The Relay UE 7 may check for a link between the DST Remote UE SRAP UE ID and a further DST Remote UE ID (e.g. a PC5 DST L2 ID) before sending the DST Remote UE SRAP UE ID to the DST Remote UE 13, 15. The Relay UE 7 accepts the DST Remote UE SRAP UE ID or rejects the DST Remote UE SRAP UE ID if there is already a conflict. To accept the DST Remote UE SRAP UE ID, the DST Remote UE 13, 15 needs to be identified with an additional ID (e.g. a PC5 DST L2 ID), which is linked to the DST Remote UE SRAP UE ID proposed by the SRC Remote UE 9, 11 e.g. PC5 DST L2 ID used by the SRC Remote UE to additionally (on top of SRAP UE ID) address/identify the peer Remote UE. This additional ID is also known to the Relay UE 7 when the SRC Remote UE 9, 11 and the DST Remote UE 13, 15 set up their PC5 direct links with the Relay UE 7 after Relay UE discovery/selection.

In another example, the Relay UE 7 assigns an SRAP UE ID for the DST Remote UE 13, 15 after receiving a message from the SRC Remote UE 9, 11. Again, this involves using an additional ID of the DST Remote UE, e.g. a DST L2 ID, and some kind of link between this additional ID and the SRAP UE ID would need to be made by the Relay UE 7.

The base station 5 of the communication network 3 which the UE-to-UE relay network 1 is a part of, may confirm a SRAP UE ID of a Remote UE 9, 11, 13, 15. The base station 5 may confirm the SRAP UE ID of the Remote UE 9, 11, 13, 15 directly with the Remote UE 9, 11, 13, 15 or may confirm the SRAP UE ID of the Remote UE 9, 11, 13, 15 via the Relay UE 7.

In certain examples, at least one UE of the UE-to-UE relay network 1 may be configured to choose an SRAP UE ID from a pool of SRAP UE IDs. The communication network 3 may manage the SRAP UE ID pool. The at least one UE may obtain the pool of SRAP UE IDs via a dedicated RRC/SIB configured connection or connect to the pool of SRAP UE IDs held on a network node including the Relay UE 7. The pool of SRAP UE IDs may be partitioned in to two sub-pools, a first sub-pool comprising SRAP UE IDs for use by Remote UEs with L2 SRC addresses ending in zero and a second sub-pool comprising SRAP UE IDs for use by Remote UEs with L2 SRC addresses ending in one. Similar partitions are possible, e.g. into five sub-pools (L2 SRC addresses ending in 0 and 5 in decimal representation use the first sub-pool, L2 SRC addresses ending in 1 and 6 use the second sub-pool, and so on). The access to the relevant ID sub-pool can alternatively or additionally be determined by properties of other identifiers and no L2 SRC addresses.

The SRAP UE ID may be any of a temporary SRAP UE ID or a permanent SRAP UE ID.

According to a second aspect of the invention there is provided a user equipment (UE) of a UE-to-UE relay network comprising a receiver, a transmitter and at least one processor configured to assign a SRAP UE ID for one or more UEs of the UE-to-UE relay network.

According to a third aspect of the invention there is provided a UE-to-UE relay network comprising at least one UE, the UE-to-UE relay network being configured to perform a method according to the first aspect of the invention.

According to a fourth aspect of the invention there is provided a computer program comprising instructions which, when the program is executed by a computer, cause the computer to carry out a method according to the first aspect of the invention.

According to a fifth aspect of the invention there is provided a computer-readable data carrier having stored thereon a computer program according to the fourth aspect of the invention.

The aspects of the invention provide solutions to the problem of assigning/con-figuring SRAP UE IDs of Remote UEs by looking at alternatives to adopting the current UE-to-UE relay network approach, whereby the base station assigns SRAP UE IDs for both Uu links and PC5 links. This is essential for UE-to-UE relay networks since the Remote UEs do not need to be in-coverage of the base station and/or RRC_CONNECTED for relaying.

FIG. 5 illustrates a structure of a UE according to an embodiment of the disclosure.

As shown in FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor. Furthermore, the UE of FIG. 5 corresponds to the UE of the FIG. 1 to FIG. 4 and FIG. 6, respectively.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

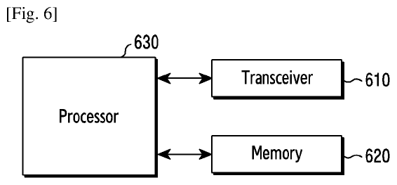

FIG. 6 illustrates a structure of a base station according to an embodiment of the disclosure.

As shown in FIG. 6, the base station according to an embodiment may include a transceiver 610, a memory 620, and a processor 630. The transceiver 610, the memory 620, and the processor 630 of the base station may operate according to a communication method of the base station described above. However, the components of the base station are not limited thereto. For example, the base station may include more or fewer components than those described above. In addition, the processor 630, the transceiver 610, and the memory 620 may be implemented as a single chip. Also, the processor 630 may include at least one processor. Furthermore, the base station of FIG. 6 corresponds to base station of FIG. 1 to FIG. 4 and FIG. 6.

The transceiver 610 collectively refers to a base station receiver and a base station transmitter, and may transmit/receive a signal to/from a terminal (UE) or a network entity. The signal transmitted or received to or from the terminal or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the base station. Also, the memory 620 may store control information or data included in a signal obtained by the base station. The memory 620 may be a storage medium, such as read-only memory (ROM), random access memory (RAM), a hard disk, a CD-ROM, and a DVD, or a combination of storage media.

The processor 630 may control a series of processes such that the base station operates as described above. For example, the transceiver 610 may receive a data signal including a control signal transmitted by the terminal, and the processor 630 may determine a result of receiving the control signal and the data signal transmitted by the terminal.

A method is provided for assigning an identifier (ID) to a user equipment (UE) in a relay network comprising configuring at least one UE of the relay network to assign a UE ID for one or more UEs of the relay network, wherein the at least one UE of the relay network is any of a Relay UE, a Remote UE.

A user equipment (UE) is provided of a relay network is provided comprising a receiver, a transmitter and at least one processor configured to assign a UE ID for one or more UEs of the relay network, wherein the at least one UE of the relay network is any of a Relay UE, a Remote UE.

The relay network may comprise any of a UE-to-UE relay network, a UE-to-Network relay network, a non-sidelink-based relay network. The UE ID may be a sidelink relay adaptation protocol (SRAP) UE ID. According to a first aspect of the invention there is provided a method for assigning an identifier (ID) to a user equipment (UE) in a relay network comprising configuring at least one UE of the relay network to assign a UE ID for one or more UEs of the relay network, wherein the at least one UE of the relay network is any of a Relay UE, a Remote UE.

The relay network may comprise any of a UE-to-UE relay network, a UE-to-Network relay network, a non-sidelink-based relay network. The UE ID may be a sidelink relay adaptation protocol (SRAP) UE ID.

In a particular example, the method may comprise assigning a sidelink relay adaptation protocol (SRAP) identifier (ID) to a user equipment (UE) in a UE-to-UE relay network comprising configuring at least one UE of the UE-to-UE relay network to assign a SRAP UE ID for one or more UEs of the UE-to-UE relay network, wherein the at least one UE of the UE-to-UE relay network is any of a Relay UE, a Remote UE.

The method may comprise configuring the at least one UE of the UE-to-UE relay network to self-assign a SRAP UE ID.

The method may comprise configuring the at least one UE of the UE-to-UE relay network to assign a SRAP UE ID for one or more other UEs of the UE-to-UE relay network.

The method may comprise configuring the at least one UE of the UE-to-UE relay network to self-assign a SRAP UE ID and to assign a SRAP UE ID for one or more other UEs of the UE-to-UE relay network.

The method may comprise configuring the at least one UE of the UE-to-UE relay network to be assigned a SRAP UE ID and to assign a SRAP UE ID for one or more other UEs of the UE-to-UE relay network.

The method may further comprise applying a conflict resolution procedure to SRAP UE IDs self-assigned to a plurality of UEs of the UE-to-UE relay network and/or assigned by the at least one UE to one or more other UEs of the UE-to-UE relay network.

The method may comprise configuring at least one Remote UE to self-assign a SRAP UE ID. The method may comprise configuring each of a plurality of Remote UEs to self-assign a SRAP UE ID.

The method may comprise configuring at least one Relay UE to self-assign a SRAP UE ID.

The method may comprise configuring at least one Relay UE to assign a SRAP UE ID to one or more Remote UEs of the UE-to-UE relay network.

The method may comprise configuring at least one Relay UE to self-assign a SRAP UE ID and to assign a SRAP UE ID to one or more Remote UEs of the UE-to-UE relay network.

The method may further comprise applying a conflict resolution procedure to SRAP UE IDs assigned to the Relay UE and the one or more Remote UEs.

The method may comprise at least one Remote UE of the UE-to-UE relay network sending a self-assigned SRAP UE ID to at least one Relay UE of the UE-to-UE relay network.

The at least one Remote UE may establish a direct connection between the at least one Remote UE and the at least one Relay UE and the at least one Remote UE may send the self-assigned SRAP UE ID to the at least one Relay UE via the connection. Sending the self-assigned SRAP UE ID to the at least one Relay UE via the connection may comprise sending the self-assigned SRAP UE ID via a PC5-S signalling transmission. Sending the self-assigned SRAP UE ID to the at least one Relay UE via the connection may comprise sending the self-assigned SRAP UE ID via a PC5 radio resource control (RRC) message, e.g. as part of a PC5 reconfiguration. Sending the self-assigned SRAP UE ID to the at least one Relay UE via the connection may comprise sending the self-assigned SRAP UE ID as part of a PC5 SRAP header of a packet transmission. Sending the self-assigned SRAP UE ID to the at least one Relay UE via the connection may comprise sending the self-assigned SRAP UE ID as part of a PC5 SRAP payload of a packet transmission.

The at least one Relay UE of the UE-to-UE relay network may send one or more received Remote UE SRAP UE IDs to one or more other Remote UEs of the UE-to-UE relay network.

The method may comprise configuring a transmit (Tx) Remote UE to assign a SRAP UE ID for a receive (Rx) Remote UE. The Tx Remote UE may send the Rx Remote UE SRAP UE ID to a Relay UE and the Relay UE may send the Rx Remote UE SRAP UE ID to the Rx Remote UE. The Relay UE may check for a link between the Rx Remote UE SRAP UE ID and a further Rx Remote UE ID before sending the Rx Remote UE SRAP UE ID to the Rx Remote UE.

The method may comprise a base station of a communication network of the UE-to-UE relay network confirming a SRAP UE ID of a Remote UE. The base station may confirm the SRAP UE ID of the Remote UE directly with the Remote UE. The base station may confirm the SRAP UE ID of the Remote UE via a Relay UE.

Configuring the at least one UE of the UE-to-UE relay network to assign a SRAP UE ID for one or more UEs of the UE-to-UE relay network may comprise configuring the at least one UE to choose the SRAP UE ID from a pool of SRAP UE IDs. The at least one UE may obtain the pool of SRAP UE IDs via a dedicated RRC/SIB configured connection. The pool of SRAP UE IDs may be partitioned in to two sub-pools, a first sub-pool comprising SRAP UE IDs for use by Remote UEs with L2 SRC addresses ending in zero and a second sub-pool comprising SRAP UE IDs for use by Remote UEs with L2 SRC addresses ending in one.

The SRAP UE ID may be any of a temporary SRAP UE ID or a permanent SRAP UE ID.

According to a second aspect of the invention there is provided a user equipment (UE) of a relay network comprising a receiver, a transmitter and at least one processor configured to assign a UE ID for one or more UEs of the relay network, wherein the UE of the relay network is any of a Relay UE, a Remote UE.

The relay network may comprise any of a UE-to-UE relay network, a UE-to-Network relay network, a non-sidelink-based relay network. The UE ID may be a sidelink relay adaptation protocol (SRAP) UE ID.

A user equipment (UE) of a UE-to-UE relay network comprising a receiver, a transmitter and at least one processor configured to assign a SRAP UE ID for one or more UEs of the UE-to-UE relay network, wherein the UE of the UE-to-UE relay network is any of a Relay UE, a Remote UE.

According to a third aspect of the invention there is provided a relay network comprising at least one UE, the relay network being configured to perform a method according to the first aspect of the invention.

According to a fourth aspect of the invention there is provided a computer program comprising instructions which, when the program is executed by a computer, cause the computer to carry out a method according to the first aspect of the invention.

According to a fifth aspect of the invention there is provided a computer-readable data carrier having stored thereon a computer program according to the fourth aspect of the invention.

According to an embodiment, a method performed by a first user equipment (UE) in a wireless communication system is provided. The method comprises configuring at least one UE identifier (ID) for one or more UEs in a relay network, establishing a direct connection for sidelink communication with a relay UE for connecting the first UE and a second UE and transmitting, to the relay UE, information on the at least one UE ID.

The relay network comprises at least one of a UE-to-UE relay network, a UE-to-Network relay network, or a non-sidelink-based relay network.

The UE ID comprises a sidelink relay adaptation protocol (SRAP) UE ID.

The transmitting of the information on the at least one UE ID comprises transmitting a self-assigned sidelink relay adaptation protocol (SRAP) UE ID via the direct connection based on at least one of a PC5-S signalling transmission or a PC5 radio resource control (RRC) message.

According to an embodiment, a first user equipment (UE) in a wireless communication system is provided. The first user equipment comprises a transceiver and a controller coupled with the transceiver and configured to configure at least one UE identifier (ID) for one or more UEs in a relay network, establish a direct connection for sidelink communication with a relay UE for connecting the first UE and a second UE and transmit, to the relay UE, information on the at least one UE ID.

The relay network comprises at least one of a UE-to-UE relay network, a UE-to-Network relay network, or a non-sidelink-based relay network.

The UE ID comprises a sidelink relay adaptation protocol (SRAP) UE ID.

The controller is further configured to transmit a self-assigned sidelink relay adaptation protocol (SRAP) UE ID via the direct connection based on at least one of a PC5-S signalling transmission or a PC5 radio resource control (RRC) message.

According to an embodiment, a method performed by a relay user equipment (UE) in a wireless communication system is provided. The method comprises establishing a direct connection for sidelink communication with a first UE and receiving, from the first UE, information on at least one UE ID associated with one or more UEs in a relay network.

The relay network comprises at least one of a UE-to-UE relay network, a UE-to-Network relay network, or a non-sidelink-based relay network.

The UE ID comprises a sidelink relay adaptation protocol (SRAP) UE ID.

The receiving of the information on the at least one UE ID comprises receiving a self-assigned sidelink relay adaptation protocol (SRAP) UE ID via the direct connection based on at least one of a PC5-S signalling transmission or a PC5 radio resource control (RRC) message.

According to an embodiment, a relay user equipment (UE) in a wireless communication system is provided. The relay UE comprises a transceiver and a controller coupled with the transceiver and configured to establish a direct connection for sidelink communication with a first UE and receive, from the first UE, information on at least one UE ID associated with one or more UEs in a relay network.

The UE ID comprises a sidelink relay adaptation protocol (SRAP) UE ID.

The controller is further configured to receive a self-assigned sidelink relay adaptation protocol (SRAP) UE ID via the direct connection based on at least one of a PC5-S signalling transmission or a PC5 radio resource control (RRC) message.

Certain examples of the present disclosure provide a UE configured to operate according to a method according to any example, embodiment, aspect and/or claim disclosed herein.

Certain examples of the present disclosure provide a wireless communication network comprising a UE according to any example, embodiment, aspect and/or claim disclosed herein.

Certain examples of the present disclosure provide a computer program comprising instructions which, when the program is executed by a computer or processor, cause the computer or processor to carry out a method according to any example, embodiment, aspect and/or claim disclosed herein.

Certain examples of the present disclosure provide a computer or processor-readable data carrier having stored thereon a computer program according to the preceding examples.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g. a network) comprising one or more such apparatuses/devices/network entities, and/or a method therefor.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but, are merely used to enable a clear and consistent understanding of the examples disclosed herein.

Throughout the description and claims, the words “comprise”, “contain” and “include”, and variations thereof, for example “comprising”, “containing” and “including”, means “including but not limited to”, and is not intended to (and does not) exclude other features, elements, components, integers, steps, processes, functions, characteristics, and the like.

Throughout the description and claims, the singular form, for example “a”, “an” and “the”, encompasses the plural unless the context otherwise requires. For example, reference to “an object” includes reference to one or more of such objects.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

While the invention has been shown and described with reference to certain examples, it will be understood by those skilled in the art that various changes in form and detail may be made therein without departing from the scope of the invention, as defined by the appended claims.

1-15. (canceled)

16. A method performed by a relay user equipment (UE) in a wireless communication system, the method comprising:
establishing a PC5 link with a peer remote UE for UE-to-UE (U2U) sidelink communication between a remote UE and the peer remote UE;
assigning an identity (ID) of the remote UE and an ID of the peer remote UE for a sidelink relay adaption protocol (SRAP); and
transmitting, to the peer remote UE, a radio resource control (RRC) message including the ID of the remote UE and the ID of the peer remote UE.

17. The method of claim 16, further comprising:
transmitting, to the remote UE, a RRC message including the ID of the remote UE and the ID of the peer remote UE.

18. The method of claim 16, wherein the RRC message further includes a layer 2 (L2) ID of the remote UE and a L2 ID of the peer remote UE.

19. The method of claim 16, further comprising:
identifying a data to be transmitted to the peer remote UE; and
determining the PC5 link for the data based on the ID of the peer remote UE.

20. The method of claim 19, wherein the data includes a SRAP header including the ID of the remote UE, the ID of the peer remote UE, and an ID of a bearer for the data.

21. The method of claim 16, wherein a bearer for the U2U sidelink communication is mapped with a radio link control (RLC) channel via a SRAP sublayer of the relay UE.

22. The method of claim 16, further comprising:
performing a discovery procedure for the U2U sidelink communication before an establishment of the PC5 link with the peer remote UE.

23. The method of claim 16, wherein a PC5 link with the remote UE is established for the U2U sidelink communication before an establishment of the PC5 link with the peer remote UE.

24. A relay user equipment (UE) in a wireless communication system, the relay UE comprising:
a transceiver; and
a controller coupled with the transceiver and configured to:
establish a PC5 link with a peer remote UE for UE-to-UE (U2U) sidelink communication between a remote UE and the peer remote UE,
assign an identity (ID) of the remote UE and an ID of the peer remote UE for a sidelink relay adaption protocol (SRAP), and
transmit, to the peer remote UE, a radio resource control (RRC) message including the ID of the remote UE and the ID of the peer remote UE.

25. The relay UE of claim 24, wherein the controller is further configured to:
transmit, to the remote UE, a RRC message including the ID of the remote UE and the ID of the peer remote UE.

26. The relay UE of claim 24, wherein the RRC message further includes a layer 2 (L2) ID of the remote UE and a L2 ID of the peer remote UE.

27. The relay UE of claim 24, wherein the controller is further configured to:
identify a data to be transmitted to the peer remote UE, and
determine the PC5 link for the data based on the ID of the peer remote UE.

28. The relay UE of claim 27, wherein the data includes a SRAP header including the ID of the remote UE, the ID of the peer remote UE, and an ID of a bearer for the data.

29. The relay UE of claim 24, wherein a bearer for the U2U sidelink communication is mapped with a radio link control (RLC) channel via a SRAP sublayer of the relay UE.

30. The relay UE of claim 24, wherein the controller is further configured to:
perform a discovery procedure for the U2U sidelink communication before an establishment of the PC5 link with the peer remote UE, and
wherein a PC5 link with the remote UE is established for the U2U sidelink communication before an establishment of the PC5 link with the peer remote UE.
